(19) United States
(12) Patent Application Publication
(10) Pub. No.: US 2009/0319598 A1
(43) Pub. Date: Dec. 24, 2009

(54) REMOTE COMMAND EXECUTION FROM MOBILE DEVICES BROKERED BY A CENTRALIZED SYSTEM

(76) Inventors: Michael Mittel, Atlanta, GA (US); Win Pham, McDonough, GA (US)

Correspondence Address: Michael Mittel, 6135 Rivercliffe Drive, Atlanta, GA, 30328, US

(21) Appl. No.: 12/482,964

(22) Filed: Jun. 11, 2009

Related U.S. Application Data
(60) Provisional application No. 61/132,571, filed on Jun. 20, 2008.

(51) Int. Cl. G06F 15/16; H04L 29/06; G06F 7/04

(52) U.S. Cl. 709/202; 709/203; 713/150; 726/4

(57) ABSTRACT

The invention relates to a system and methodology of allowing users to easily execute commands for the purpose verification, diagnosis, remediation, and communication from the perspective of a remote computer from their mobile device. The invention requires installation of a robot on the remote computer where commands will be executed. The configuration of the pre-defined commands, which are pre-built actions can be carried out by the robot along with their parameters.

This application claims the benefit, pursuant to 35 U.S.C. §119(e), of U.S. Provisional Patent Application entitled “REMOTE COMMAND EXECUTION FROM MOBILE DEVICES BROKERED BY A CENTRALIZED SYSTEM,” filed on Jun. 20, 2008 and assigned application No. 61/132,571 the disclosure of which is incorporated herein by reference in its entirety.

### FIELD OF THE INVENTION

The invention relates to a system and method for execution of commands on a remote computer from a mobile device. More particularly, the invention relates to a system and method for execution of commands on a remote computer from a mobile device for the purposes of verification, diagnose, remediation, and communication regarding a condition of the remote computer or device managed by the remote computer.

### BACKGROUND OF THE INVENTION

Many computer monitoring systems exist for the purpose of detecting a state or condition of a computer system or of the applications running on it. Once an “alarm” has been detected, it needs to be verified, diagnosed, remediated, and eventually the status of the alarm needs to be communicated to others. In many cases, the various tasks are done through a computer with remote control capabilities and then using many tools on an ad-hoc basis.

Remote control involves logging into a remote computer system as if one is a user of that system. The effect is to have the same access rights, control, and display as if the user were sitting at the local keyboard and display. Several remote control solutions offer variations, which allow tunneling and in some cases, the remote control display can be transmitted to a mobile device.

The issue with remote control on a mobile device is that most remote control solutions were designed to be used on a desktop computer with a full display and mouse. Mobile devices have limited navigation, bandwidth, and display making it cumbersome to use traditional remote control

### SUMMARY

The invention relates to a system and methodology of allowing users to easily execute commands for the purpose of verification, diagnosis, remediation, and communication from the perspective of a remote computer from their mobile device. The invention requires installation of a robot on the remote computer where commands will be executed. The configuration of the pre-defined commands, which are pre-built actions can be carried out by the robot along with their parameters.

The user interface for executing these remote commands consists mostly of listings of robots, their groupings, pre-defined searches, and their commands, such that navigation can be done by navigating around hyperlinks rather than controlling a screen with a mouse.

Both the robots and mobile device connect to a central backend server that acts as a broker for the transactions, alleviating connectivity issues related to mobile devices and robots on remote systems with firewalls. The central server ensures security of the transaction and then authentication of the mobile device user. It also centrally stores the commands to be executed. The robots will periodically connect with the backend server through a web service call requesting the command to be executed, perform the command, and return the result. Commands can be scheduled to be executed in the future as well at a pre-determined time. The central server acts as a scheduler and mediator for this transaction.

Further, some actions may be scheduled and executed in a long-running process. In such cases, the user of the mobile device will be notified that the command was accepted and allowed to continue. Then when the robot has executed the command, the result will be sent to the mobile device either as an email or an alert to the mobile interface.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 is a diagram of a prior art basic remote desktop/screen sharing.

FIG. 2 is a diagram of a prior art remote management through a directly connected tool.

FIG. 3 is a diagram illustrating preferred component features of aspects of the present invention.

FIG. 4 is a flow chart illustrating a preferred function of the robot.

FIG. 5 is a flow chart illustrating a preferred function of the central broker.

FIG. 6 is a diagram illustrating the components of a command.

FIG. 7 is a diagram illustrating the preferred user interface for mobile devices that can be utilized within embodiments of the present invention.

### DETAILED DESCRIPTION

One or more exemplary embodiments of the invention are described below in detail. The disclosed embodiments are intended to be illustrative only since numerous modifications and variations therein will be apparent to those of ordinary skill in the art. In reference to the drawings, like numbers will indicate like parts continuously throughout the views.

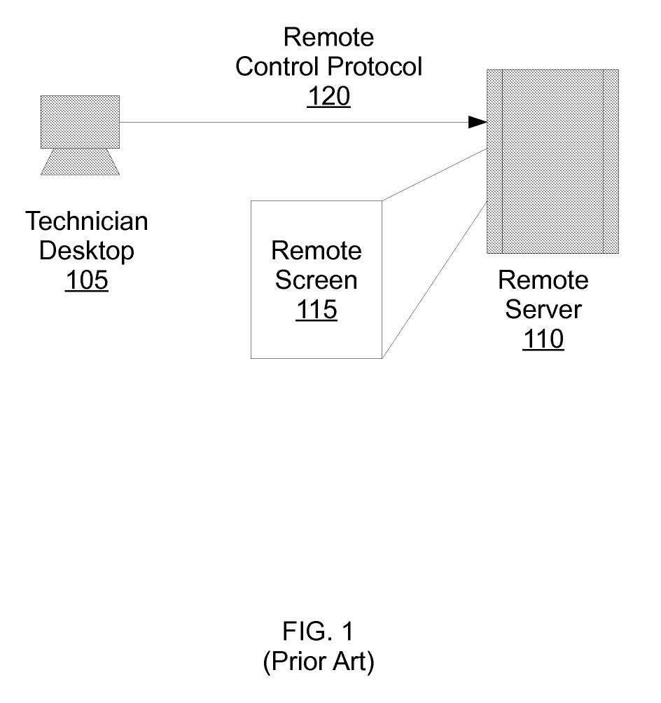

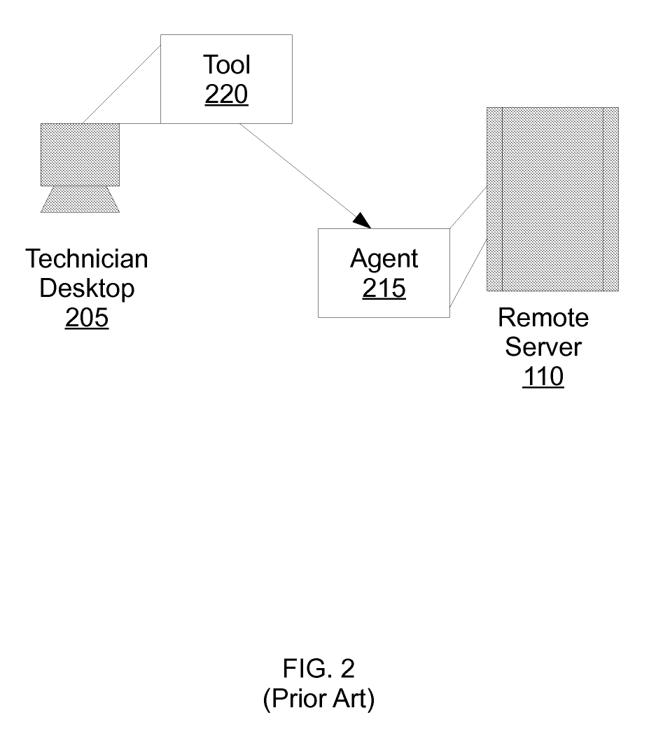

Aspects of the present invention relate to a next generation system for performing commands on remote computer systems and devices primarily from mobile devices. Traditionally, there have been two primary methodologies of accessing remote systems. FIG. 1, remote screen sharing, illustrates systems where a rendition of the screen or virtual screen on a remote system 110 is replicated. This can be accomplished by terminal or remote desktop protocols. FIG. 2, tool based control, illustrates existing systems where a program is run directly on the technician's desktop 205 and accesses an agent 215 on a remote server 110. In this model, the tools 220 communicates directly with the agent 215 and results are displayed immediately on the tool.

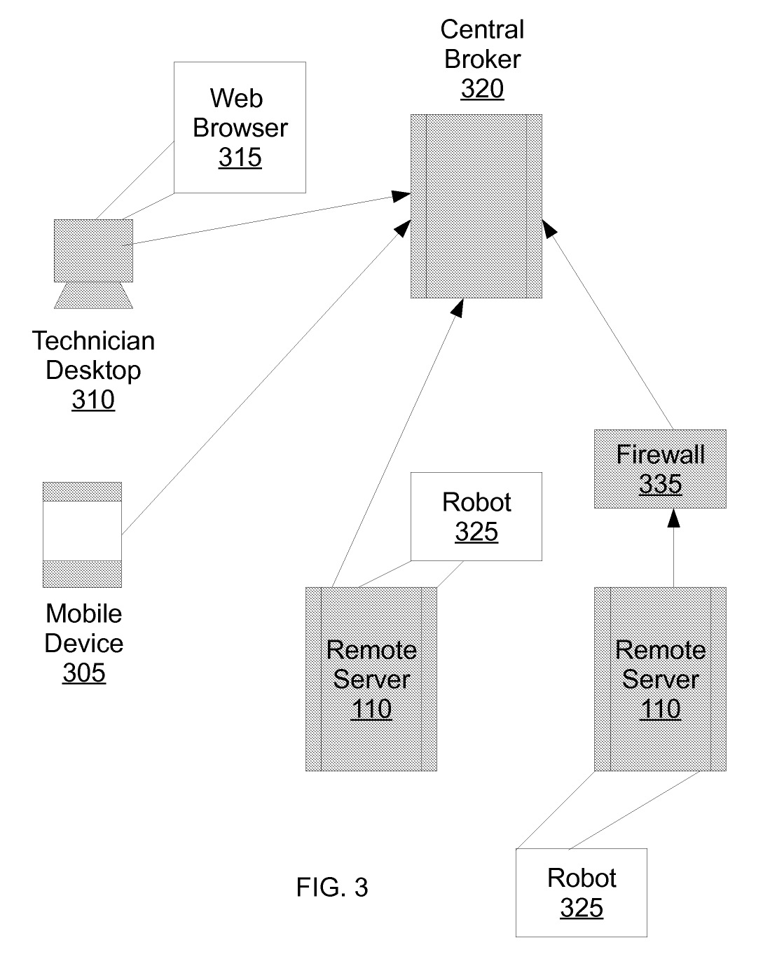

Mobile devices present unique issues in that direct connections are not always possible. As depicted in FIG. 3, the present invention resolves this issue by employing a central broker 320 that acts as an intermediary between the mobile device 305 and the remote server 110. Modern mobile devices have access to web-based requests systems, either threw a web browser 315 or a programmatic interface running on the mobile device 305 directly. Requests are sent to the central broker 320, which queues up the requests for robots 325. Robots 325 periodically poll the central broker 320, carry out commands and return the results to the central broker 320 to pass back to the mobile device 305 or technician's desktop 310. The protocol employed by the robot 325 must be able to tunnel through firewalls 335 and be outbound only for security reasons. An embodiment of the present invention is to use the HTTPS protocol.

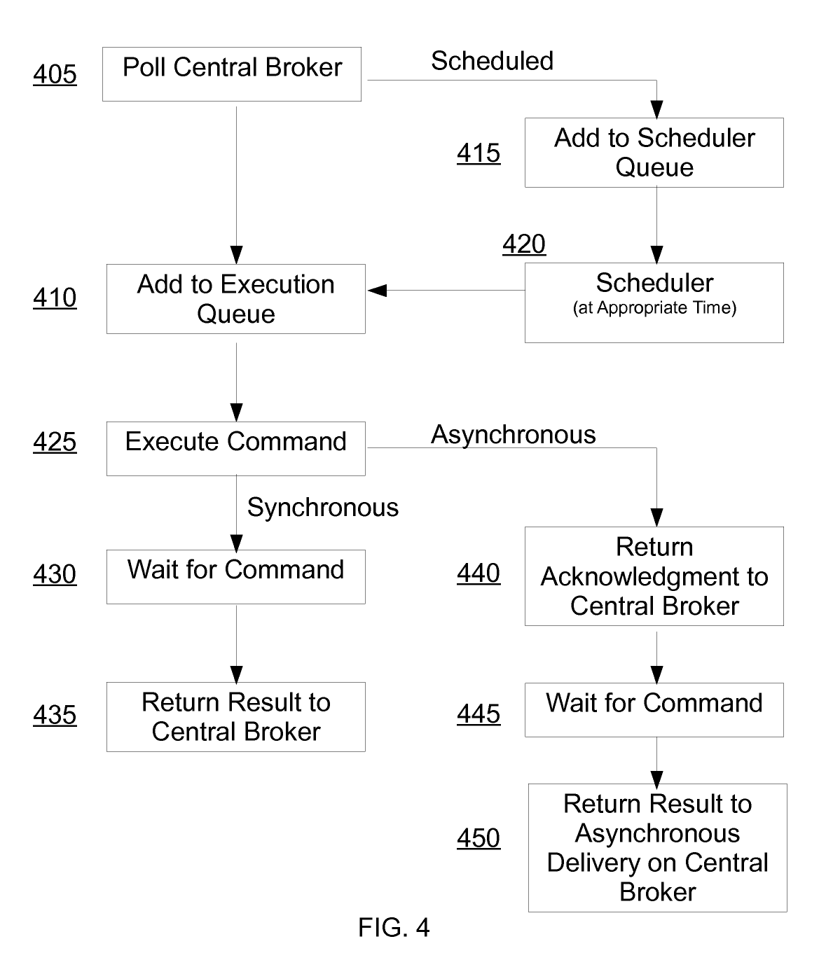

FIG. 4 illustrates the preferred embodiment of the robot 325 function. Periodically, the robot 325 will poll the central broker 320 as shown in step 405. The result from the poll can be no command at this time or a command request. If the command request is marked as scheduled, it is added to the schedule queue 415. The scheduler 420 periodically checks the queue to see if it should execute. When the scheduler finds a command request to execute it queues it adds it to the execution queue 410. If the command request was not flagged as scheduled, it will be immediately added to the execution queue 410. Command are then executed 425. If the command is flagged as asynchronous, acknowledgment of the execution is returned immediately to the central broker 440. The robot continues to wait for the command 445. When the result from the command execution is returned it is sent back to the central broker 450. Asynchronous execution is of extreme value in situations where a mobile device needs to be used to execute commands. In many cases, the commands may be long running and connectivity from mobile devices may be extremely transient. Synchronous commands are executed 425 then the robot goes into a wait state for the result 430. The result is then immediately passed back to the central broker 435.

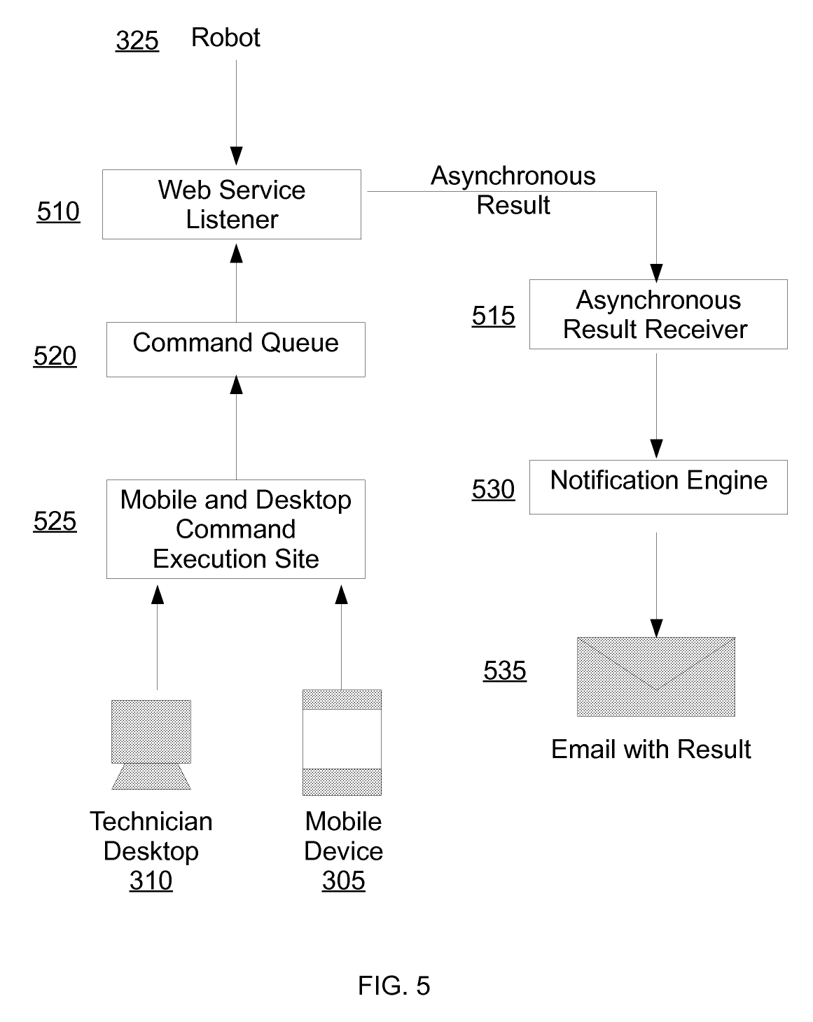

The flow chart depicted in FIG. 5 illustrates the preferred embodiment of the central broker 320. The robot 325 periodically polls the central broker 320 through a web service call to the web services listener 510. If the poll is an asynchronous result, it is routed to the asynchronous result receiver 515 and then sent to the notification engine 530. In this particular embodiment, the notification engine can send out an email 535. If the request being sent to the web service listener 510 is a request for command and not an asynchronous result, the web service listener 510 polls the command queue 520 for commands for the robot 325. All appropriate commands are sent back to the robot 325. From the Mobile and Desktop Execution Site 525, technicians from a desktop 310 or a mobile device 305 can add commands to the command queue 520.

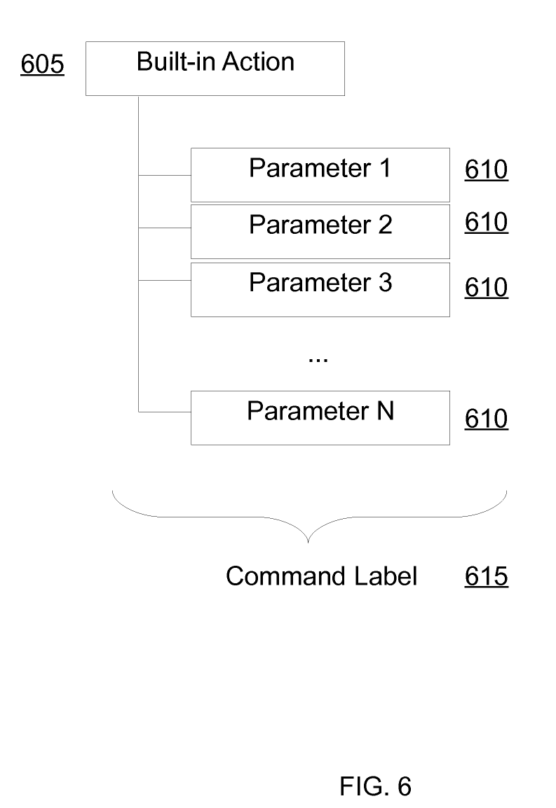

A significant aspect of the present invention is the concept of a command. FIG. 6 shows the structure of commands. A command is defined as a built-in action 605 along with a set of parameters 610. The significance of the command definition is that it embodies predefined parameters by a command label 615 that can be used in an optimized mobile interface.

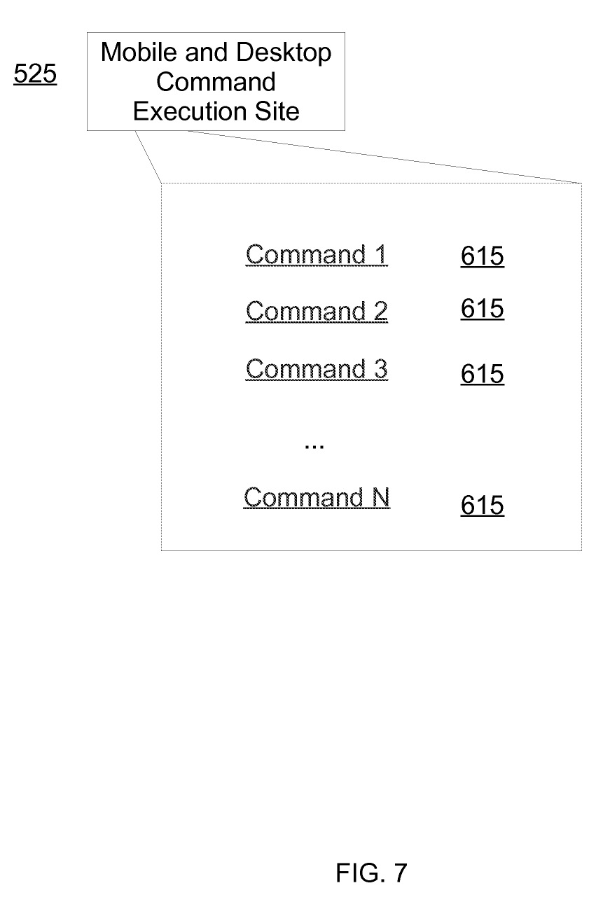

The command labels 615 form the basis of embodiment of the mobile interface depicted in FIG. 7. To adhere to the constraints of small screen navigation, no typing or minimal typing is needed and a list of command labels 615 set-up as hyperlinks is presented in various listings. FIG. 7 shows a possible embodiment of the present invention's mobile interface as a vertical listing that is highly compatible with all modern cellular devices.

The uniqueness of the present invention lies in its ability to execute commands on remote systems taking into account the nature of mobile devices and the limitations thereof. The present invention removes barriers to command execution in mobile environments on a host of servers using a central broker 320 and utilizing a unique command interface 525 that allows encapsulation of actions and parameters into command labels 615, allowing technicians to easily perform commands remotely on a remote server from a mobile device giving interface limitations.

What is claimed:

1. A system for the execution of commands on a remote computer system from a mobile device, the system comprising:
a central server acting as a common point of contact;
at least one robot, wherein the robot is in communication with the central server; and
a mobile device used to execute commands, wherein the mobile device is in communication with the central server.

2. The system of claim 1, further comprising a central server acting as a common point of contact, the central server comprising:
a web service listening for requests from the robot;
a secure authentication and encryption scheme;
a scheduling mechanism capable of executing commands at a future time;
an asynchronous result system wherein commands can be sent to a robot while the mobile user is allowed to return to other activities;
a synchronous result system wherein the mobile user must wait for results from the robot before continuing;
a web site allowing the configuring of pre-defined commands; and
a web site designed for the navigation, selection of and execution of commands on the robot by users both on traditional web browsers as well as mobile devices.

3. The system of claim 1, further comprising one or more robots capable of executing commands on a remote device, the robots comprising:
a mechanism for securing and authenticating communication with the central server using a web service call;
a set of built-in commands for purposes of verification, diagnosis, remediation, and communication regarding the historical, current, or future state of the managed device;
an engine for tailoring of built-in commands using parameters passed down from the central server;
a mechanism for restricting which commands can be executed by the robot, regardless of the requests issued by the central server; and
a mechanism to execute commands synchronously or asynchronously;

4. The system of claim 1, further comprising of a mobile interface optimized for locating, navigating to, and executing remote commands, the mobile interface comprising:
a method of navigation which does not involve a mouse and free movement;
limited typing requirement;
